(19) United States
(12) Patent Application Publication
(10) Pub. No.: US 2022/0302523 A1
(43) Pub. Date: Sep. 22, 2022

(54) METHODS AND SYSTEMS FOR A BATTERY HOUSING

(71) Applicant: Dana Automotive Systems Group, LLC, Maumee, OH (US)

(72) Inventors: Christopher M. Cook, McKenzie, TN (US); Matthew K. Paschall, Medina, TN (US)

(21) Appl. No.: 17/649,138

(22) Filed: Jan. 27, 2022

Related U.S. Application Data
(60) Provisional application No. 63/163,581, filed on Mar. 19, 2021.

(51) Int. Cl. H01M 10/6556; H01M 10/613; H01M 10/653

(52) U.S. Cl. CPC H01M 10/6556; H01M 10/613; H01M 10/653; H01M 2220/20

(57) ABSTRACT

Methods and systems are provided for a cold-plate. In one example, a method comprises laser welding a tray to a frame, wherein a gasket is arranged between beads of the laser welding.

### CROSS REFERENCE TO RELATED APPLICATION

The present application claims priority to U.S. Provisional Application No. 63/163,581, entitled “METHODS AND SYSTEMS FORA BATTERY HOUSING”, and filed on Mar. 19, 2021. The entire contents of the above-listed application are hereby incorporated by reference for all purposes.

### TECHNICAL FIELD

The present description relates generally to a cold-plate for a battery housing.

### BACKGROUND AND SUMMARY

Concern over climate change is leading manufacturers to switch energy sources from fossil fuels to other energy sources, such as electricity. This includes a variety of transportation categories including vehicles, trucks, boats, motorcycles, airplanes, trains, and other transportation devices.

Performance demands continue to increase for electrified transportation vehicles with regards to power output and drive range. Increases in power and drive range may also result in increased heat generation and a need to cool electric motors and other electric devices. In configuring increased cooling demands, noise, vibration, and harshness (NVH) may increase along with packaging constraints, which restrict a number of applications in which the cooling system may be used. As such, examples of previous cooling systems may need modifications to fit advanced electric motor designs to meet a variety of applications, which may be expensive and time consuming.

Other examples of addressing electric motor cooling include modifying a cooling plate of a battery of an electrified vehicle. One example approach is shown in U.S. 2019/0366877 by Blersch et al. Therein, one or more cooling plates of a battery are connected with a tunnel or tunnels arranged between cooling plates for transporting coolant. Metal plate shaped sections of the cooling plates are joined together via weld seams, such as stitch welds, wobble welds, or other similar welds via a laser beam.

However, the inventors have identified some issues with the approaches described above. For example, the cooling plates of Blersch include a plurality of layers to shape the tunnels for conducting coolant. This increases a packaging size and complexity of the cooling plate(s). Furthermore, a complexity in manufacturing the cooling plate is increased due to a need to weld the layers together prior to welding the plate to the battery. This results in increased costs and increased joints at which leaks may occur.

In one example, the issues described above may be addressed by a method for manufacturing a mixed material cold plate comprising a tray, a frame, and a gasket, wherein the tray and the frame are laser welded to one another. In this way, a weight and a size of the cold-plate may be reduced relative to the example shown by Blersch.

As one example, the gasket is arranged in a groove of the tray, wherein the frame presses against the gasket and comes into face-sharing contact with the tray. The gasket, along with the laser welded bead and/or joint may seal an outer edge of the cold-plate to block coolant from leaking. The tray may comprise one or more coolant channels integrally arranged thereon, wherein the coolant channels are configured to conduct coolant therethrough. The coolant may absorb heat from a heat sink of a battery to reduce a temperature thereof.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example of an at least partially electrified vehicle.

FIG. 2 illustrates a cross-section of a cold-plate assembly taken along cutting plane 2-2 of FIG. 4.

FIG. 3 illustrates a partial cross-section of the cold-plate assembly illustrating welds of the cold-plate assembly.

FIG. 4 illustrates an isometric view of the cold-plate assembly.

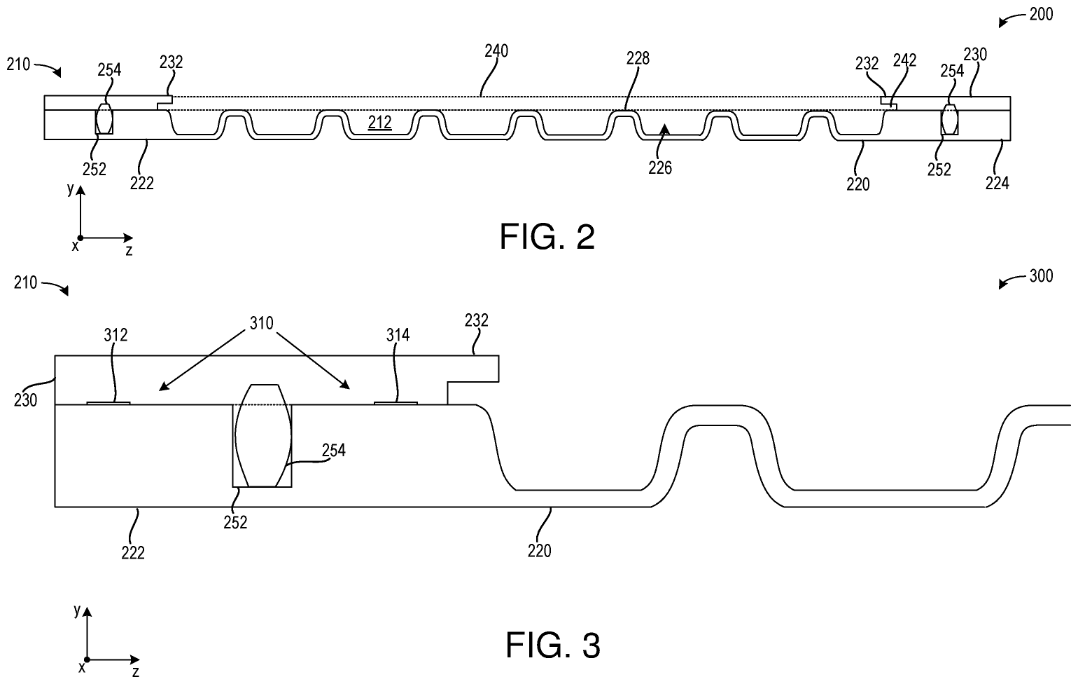

FIGS. 2-4 are shown approximately to scale, however, other relative dimensions may be used if desired.

### DETAILED DESCRIPTION

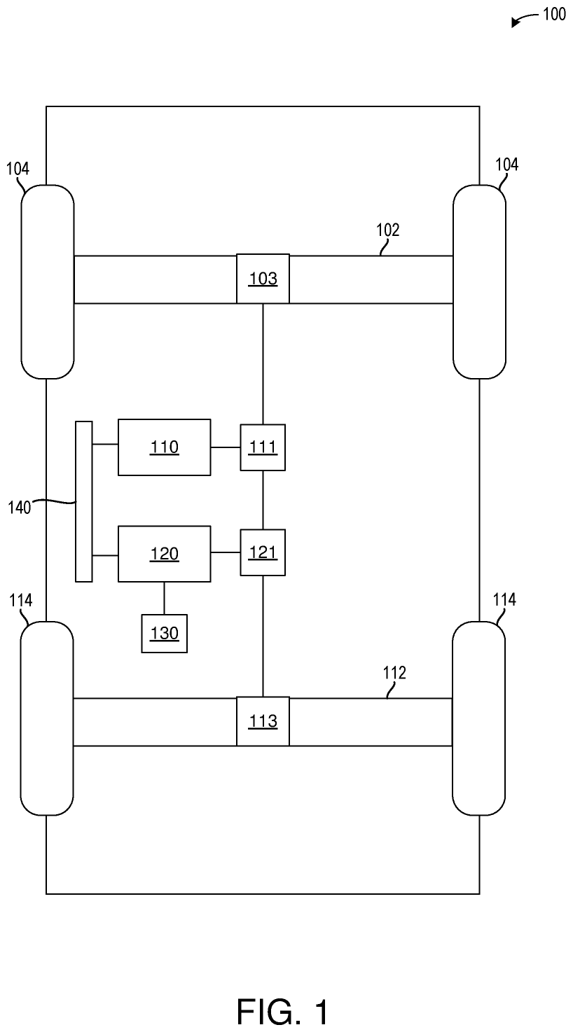

The following description relates to systems and methods for a cold-plate assembly. The cold-plate assembly may be configured to maintain a desired temperature of a battery. In one example, the battery is an electric storage device of a vehicle, as illustrated in FIG. 1. The battery may be configured to provide electrical energy to an electric motor along with other components of the vehicle.

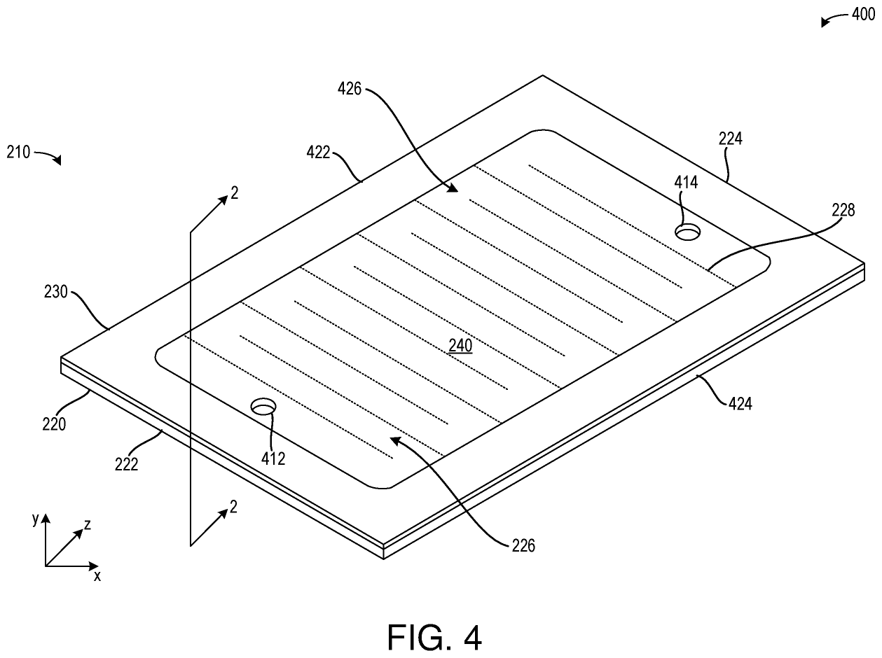

The cold-plate assembly comprises a tray, a frame and a gasket, as illustrated in the cross-section of FIG. 2. The tray further comprises a plurality of coolant channels integrally shaped thereon, that allow coolant flow between the plurality of coolant channels and a heat sink of the cold-plate assembly. A coupling between the tray and the frame is illustrated in greater detail in FIG. 3, which shows a partial view of the cross-section of FIG. 2. An isometric view of the cold-plate assembly is illustrated in FIG. 4. The isometric view illustrates a view of the heat sink which includes a coolant inlet and a coolant outlet for allowing coolant to enter and exit an interior volume of the cold-plate assembly.

FIGS. 1-4 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

Turning now to FIG. 1, it shows a vehicle 100 comprising a first shaft 102 and a second shaft 112. The first shaft 102 may be configured to drive a first set of wheels 104 and the second shaft 112 may be configured to drive a second set of wheels 114. In one example, the first shaft 102 is arranged near a front of the vehicle 100 and the second shaft 112 is arranged near a rear of the vehicle 100.

An engine 110 may be coupled to a first gear box 111 and an electric motor 120 may be coupled to a second gear box 121. Each of the first gear box 111 and the second gear box 121 may transfer power to a first differential 103 arranged on the first shaft 102 and a second differential 113 arranged on the second shaft 112. In one example, the engine 110 and the electric motor 120 are arranged in a power-series hybrid configuration. However, it will be appreciated by those of ordinary skill in the art that the hybrid configuration of the vehicle 100 may be in a different form without departing from the scope of the present disclosure.

The electric motor 120 is configured to receive energy from a battery 130. The electric motor 120 and the engine 110 are fluidly coupled to a common cooling system 140. In one example, the cooling system 140 flows a liquid, such as oil, coolant, water, or the like, to coolant passages of each of the engine 110 and the electric motor 120. Additionally or alternatively, coolant from the electric motor 120 may flow to the battery 130. In some examples, additionally or alternatively, coolant may flow to the battery 130 directly from the cooling system 140.

Herein, the vehicle 100 is at least partially electrically driven. In one example, the vehicle 100 is an all-electric vehicle comprising one or more batteries for powering one or more electric motors to drive the vehicle.

Turning to FIG. 2, it shows a cross-sectional view 200 taken along cutting plane 2-2 of FIG. 4. The cross-sectional view 200 reveals an interior volume 212 of a cold-plate assembly 210. The interior volume 212 may be defined via one or more of a tray 220, a frame 230, and a heat sink 240.

The tray 220 may include a first extreme end 222 and a second extreme end 224, opposite the first extreme end 222. In one example, the tray 220 may comprise multiple sides, wherein the extreme ends illustrated in the embodiment of FIG. 2 may represent only a portion of two of the sides. Thus, the first extreme end 222 may illustrate a cross-section of a first side and the second extreme end 224 may illustrate a cross-section of a second side, opposite the first side.

The first extreme end 222 and the second extreme end 224 may be identical to one another in size and shape. Each of the first extreme end 222 and the second extreme end 224 comprises a groove 252. In one example, the groove 252 may be a single groove extending around an entire length (e.g., a circumference) of the tray 220. The groove 252 may be arranged proximal to a central portion of the first extreme end 222 and the second extreme end 224.

The groove 252 may be configured to receive a gasket 254. In one example, a width of the groove 252, measured along the z-axis, may correspond to a width of the gasket 254 such that the gasket 254 may be in face-sharing contact with surfaces of the groove 252. A height of the groove 252, measured along the y-axis, may be shorter than a height of the gasket 254. As such, the gasket 254 may protrude from the groove 252 in a direction parallel to the y-axis.

The frame 230 may be pressed against a surface of the tray 220 at which the groove 252 and the gasket 254 are arranged. That is to say, the frame 230 presses against the surface of the tray 220 at which the groove 252 is open. The frame 230 may compress the gasket 254 as it moves toward and comes into face-sharing contact with the tray 220. A compressed configuration of the gasket 254 is illustrated via a dashed line. The gasket 254 may be flush with a top of the groove 252 when the frame 230 and the tray 220 are pressed against one another.

The frame 230 may include an inner protrusion 232 with extends around an entire interior perimeter of the frame 230. As such, the inner protrusion 232 may extend toward the interior volume 212 of the cold plate assembly 210. The inner protrusion 232 may be shaped to reveal a portion of the surface of the tray 220 at which the frame 230 is in face-sharing contact.

The heat sink 240 may be coupled to the frame 230 and the tray 220. In one example, the heat sink 240 may include an outer protrusion 242 extending around an outer perimeter of the heat sink 240. The outer protrusion 242 may be arranged between the surface of the tray 220 and the frame 230. In one example, the outer protrusion 242 may be sandwiched between the surface of the tray 220 and the inner protrusion 232 of the frame 230. In this way, the heat sink 240 may be blocked from moving along the x-, y-, and z-axes.

The heat sink 240 may comprise a material identical to or different than a material of the tray 220 and the frame 230. In one example, the heat sink 240 includes a metal, such as aluminum. Additionally or alternatively, the heat sink 240 may include other materials, such as magnesium, carbon fiber, or the like. The tray 220 and the frame 230 may comprise a composite material, such as a polymer. In one example, the polymer may include a plastic, however, the polymer may be in other forms in some embodiments. Some examples of the materials included in the composite material may include collagen, ceramic, metal, concrete, reinforced polymers, including fiber-reinforced polymers, carbon fiber reinforced polymers, glass-reinforced plastics, thermoplastics, short fiber thermoplastics, long fiber thermoplastics, thermoset, polymer matrices, epoxy resin matrices doped with aramid and carbon fibers, paper composite panels, and the like.

As illustrated in the partial cross-section view 300 of FIG. 3, a coupling 310 is arranged on both sides of the groove 252 and the gasket 254. As such, components previously introduced are similarly numbered in this figure and subsequent figures. The coupling 310 comprises a first joint 312 and a second joint 314, which may be arranged about the gasket 254, with the second joint 314 being closer to the interior volume 212 than the first joint 312. The first joint 312 and the second joint 314 may be symmetrically arranged about the gasket 254. In some examples, additionally or alternatively, the first joint 312 and the second joint 314 may be asymmetrically arranged about the gasket 254. In one example, one or more of the first joint 312 and the second joint 314 is a bead. The first joint 312 and the second joint 314 may be laser welded, wherein the first joint 312 and the second joint 314 fixedly couple the tray 220 and the frame 230. In one example, the first joint 312 and the second joint 314 maintain the tray 220 and the frame 230 in face-sharing contact, such that the first joint 312, the second joint 314, and the gasket 254 hermetically seal the interior volume 212 of the cold-plate assembly 210.

In one example, to utilize a laser welding process to produce the first joint 312 and the second joint 314, one of the tray 220 and the frame 230 may be laser translucent while the other may be laser absorbent. Thus, if the tray 220 is laser translucent then the frame 230 may be laser absorbent. In one example, a laser translucence and a laser absorbance may be based on a tint or other characteristic, wherein the frame 230 may be more opaque than the tray 220. The tray and frame 230 may be pressed together during the laser welding process.

Turning now to FIG. 4, it shows an isometric view 400 of the cold-plate assembly 210. As illustrated, the cold-plate assembly 210, which includes the tray 220, the frame 230, and the heat sink 240, comprises a rectangular prism shape. However, it will be appreciated that the cold-plate assembly 210 may comprise a variety of shapes based on a shape of the battery (e.g., battery 130 of FIG. 1). For example, the cold-plate assembly may comprise a triangular prism shape, a cube shape, a trapezoidal prism shape, or other polyhedral shape.

The heat sink 240, which may be in direct face-sharing contact with a portion of the battery and configured to absorb heat therefrom, may include a coolant inlet 412 and a coolant outlet 414. The coolant inlet 412 may be configured to receive coolant from one or more of a coolant system (e.g., cooling system 140), an electric motor (e.g., electric motor 120), or other device which receives coolant. The coolant inlet 412 may be configured to expel coolant to one or more of the coolant system, the electric motor, a degas bottle, or other device which receives coolant.

The coolant inlet 412 may admit coolant to a plurality of coolant channels 226 of the tray 220, as illustrated in FIGS. 2 and 3. Coolant may flow in a serpentine manner through the plurality of coolant channels 226, from an area adjacent the first extreme end 222 proximal to the coolant inlet 412, to an area adjacent the second extreme end 224, proximal to the coolant outlet 414. In this way, coolant flow through the interior volume of the cold-plate assembly 210 may be repeatedly reversed. By doing this, heat transfer between the heat sink 240 and the coolant may be enhanced, such that the coolant may decrease a temperature of the heat sink 240 during some conditions.

Returning to FIG. 2, the plurality of coolant channels 226 may be molded directly onto the tray 220. In one example, the plurality of coolant channels 226 are shaped via only the tray 220, wherein the tray 220 is a single, continuous piece. The tray 220 may include dividers 228, wherein the dividers 228 may separate adjacent coolant channels and force coolant to flow through an entirety of the interior volume 212.

As illustrated in FIG. 4, the dividers 228, illustrated via dashed lines, may extend in a direction substantially normal to a first long side 422 and a second long side 424. The first long side 422 and the second long side 424 may be parallel to one another and normal to the first extreme end 222 and the second extreme end 224. Coolant flow through the plurality of coolant channels 226 is substantially normal to the first long side 422 and the second long side 424 except at intersections 426 of the plurality of coolant channels 226. The intersections 426 may correspond to regions of the interior volume 212 where the dividers 228 are not in contact with one of the first long side 422 or the second long side 424. As illustrated, the dividers 228 may alternate such that a first divider is in contact with only the first long side 422, and a second divider, directly adjacent to the first divider, is in contact with only the second long side 424. In such an example, an intersection may be arranged at an extreme end of the first divider, between it and the second long side 424. Coolant flow through the intersection may turn in a direction normal to each of the first extreme end 222 and the second extreme end 224. In one example, coolant flow in a first coolant channel flows in a first direction, wherein the coolant turns to flow into a second coolant channel directly adjacent the first coolant, wherein coolant flow through the second coolant channel is in a second direction opposite the first direction. The coolant flow may continue to serpentine through the plurality of coolant channels 226 until it reaches the coolant outlet 414, where the coolant is conducted out of the interior volume 212 of the coolant plate assembly 210.

As illustrated in FIGS. 2 and 3, the dividers 228 may include a cone shape, wherein a tip of the cone may be curved and in face-sharing contact with the heat sink 240. As such, the dividers 228 may block coolant from flowing between the dividers and the heat sink 240. In this way, the dividers force the coolant to flow to a subsequent channel via only the intersections arranged between the dividers and one of the long sides. In one example, a divider comprises a triangular cross-sectional shape, wherein the cross-section is taken along the y-z plane.

In this way, a coolant plate assembly may comprise three pieces, including a frame, a tray, and a heat sink. The frame may be physically coupled to the tray via one or more laser welds, which may press the frame and the tray together to compress a gasket arranged therebetween. An interior volume of the cold-plate assembly may comprise a plurality of coolant shaped the frame. The technical effect of the cold-plate assembly is to provide a desired cooling capacity while reducing a weight and size of the cold-plate assembly.

The disclosure provides support for a method comprising manufacturing a mixed material cold plate comprising a tray, a frame, and a gasket, wherein the tray and the frame are laser welded to one another. A first example of the method further includes compressing the gasket via the tray and the frame between a pair of laser welds. A second example of the method, optionally including the first example, further includes molding a plurality of coolant channels on the tray. A third example of the method, optionally including one or more examples, further includes where positioning a cold-plate between the tray and the frame prior to the tray and the frame being laser welded to one another. A fourth example of the method, optionally including one or more examples, further includes where the tray and the frame comprise a composite material. A fifth example of the method, optionally including one or more examples, further includes where fluidly coupling an interior volume of the mixed material cold-plate to a coolant system.

The disclosure further provides support for a system including a battery and a cold-plate comprising a tray, a frame, and a heat sink, wherein the tray and the frame comprise composite materials configured to be physically coupled via laser welding, and wherein the tray comprises a groove configured to receive a gasket. A first example of the system further includes where the frame is in face-sharing contact with the tray, and wherein the gasket is compressed between the tray and the frame. A second example of the system, optionally including the first example, further includes where laser welding comprises a first weld and a second weld, wherein the groove and the gasket are arranged between the first weld and the second weld. A third example of the system, optionally including one or more examples, further includes where the frame comprises an inner protrusion adjacent to an interior volume of the cold-plate, and wherein the heat sink is sandwiched between the inner protrusion and the tray. A fourth example of the system, optionally including one or more examples, further includes where the frame comprises a plurality of dividers molded thereon, and wherein adjacent dividers are spaced away from one another. A fifth example of the system, optionally including one or more examples, further includes where coolant flows between the plurality of dividers, and wherein coolant enters an interior volume of the cold-plate via a coolant inlet arranged in the heat sink, and wherein the coolant exits the interior volume of the cold-plate via a coolant outlet arranged in the heat sink. A sixth example of the system, optionally including one or more examples, further includes where the coolant inlet receives coolant from one or more of a coolant system and an electric motor. A seventh example of the system, optionally including one or more examples, further includes where the coolant outlet expels coolant to one or more of the coolant system, the electric motor, and a battery. An eighth example of the system, optionally including one or more examples, further includes where the heat sink comprise aluminum, and wherein the tray and the frame comprise a composite material, wherein the composite material comprises one or more of collagen, ceramic, metal, concrete, reinforced polymers, including fiber-reinforced polymers, carbon fiber reinforced polymers, glass-reinforced plastics, thermoplastics, short fiber thermoplastics, long fiber thermoplastics, thermoset, polymer matrices, epoxy resin matrices doped with aramid and carbon fibers, and paper composite panels. A ninth example of the system, optionally including one or more examples, further includes where one of the tray or the frame is laser translucent and the other laser absorbent, wherein the tray and the frame are pressed together during a laser welding process.

The disclosure further provides support for a battery including a cold-plate comprising a tray, a frame, and a heat sink, wherein the tray and the frame comprise composite materials configured to be physically coupled via laser welding, and wherein the tray comprises a groove configured to receive a gasket, and wherein a laser welded bead is arranged between the gasket and an interior volume of the cold-plate. A first example of the battery further includes where the tray comprises a plurality of coolant channels, wherein adjacent channels of the plurality of coolant channels are separated via dividers of the tray. A second example of the battery, optionally including the first example, further includes where the interior volume is hermetically sealed apart from a coolant inlet and a coolant outlet arranged on the heat sink. A third example of the battery, optionally including one or more of the previous examples, further includes where the frame is laser translucent and the tray is laser absorbent.

The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method comprising:
manufacturing a mixed material cold plate comprising a tray, a frame, and a gasket, wherein the tray and the frame are laser welded to one another.

2. The method of claim 1, further comprising compressing the gasket via the tray and the frame between a pair of laser welds.

3. The method of claim 1, further comprising molding a plurality of coolant channels on the tray.

4. The method of claim 1, further comprising positioning a cold-plate between the tray and the frame prior to the tray and the frame being laser welded to one another.

5. The method of claim 1, wherein the tray and the frame comprise a composite material.

6. The method of claim 1, further comprising fluidly coupling an interior volume of the mixed material cold-plate to a coolant system.

7. A system, comprising:
a battery; and
a cold-plate comprising a tray, a frame, and a heat sink, wherein the tray and the frame comprise composite materials configured to be physically coupled via laser welding, and wherein the tray comprises a groove configured to receive a gasket.

8. The system of claim 7, wherein the frame is in face-sharing contact with the tray, and wherein the gasket is compressed between the tray and the frame.

9. The system of claim 7, wherein laser welding comprises a first weld and a second weld, wherein the groove and the gasket are arranged between the first weld and the second weld.

10. The system of claim 7, wherein the frame comprises an inner protrusion adjacent to an interior volume of the cold-plate, and wherein the heat sink is sandwiched between the inner protrusion and the tray.

11. The system of claim 7, wherein the frame comprises a plurality of dividers molded thereon, and wherein adjacent dividers are spaced away from one another.

12. The system of claim 11, wherein coolant flows between the plurality of dividers, and wherein coolant enters an interior volume of the cold-plate via a coolant inlet arranged in the heat sink, and wherein the coolant exits the interior volume of the cold-plate via a coolant outlet arranged in the heat sink.

13. The system of claim 12, wherein the coolant inlet receives coolant from one or more of a coolant system and an electric motor.

14. The system of claim 13, wherein the coolant outlet expels coolant to one or more of the coolant system, the electric motor, and a battery.

15. The system of claim 7, wherein the heat sink comprise aluminum, and wherein the tray and the frame comprise a composite material, wherein the composite material comprises one or more of collagen, ceramic, metal, concrete, reinforced polymers, including fiber-reinforced polymers, carbon fiber reinforced polymers, glass-reinforced plastics, thermoplastics, short fiber thermoplastics, long fiber thermoplastics, thermoset, polymer matrices, epoxy resin matrices doped with aramid and carbon fibers, and paper composite panels.

16. The system of claim 7, wherein one of the tray or the frame is laser translucent and the other laser absorbent, wherein the tray and the frame are pressed together during a laser welding process.

17. A battery, comprising:
a cold-plate comprising a tray, a frame, and a heat sink, wherein the tray and the frame comprise composite materials configured to be physically coupled via laser welding, and wherein the tray comprises a groove configured to receive a gasket, and wherein a laser welded bead is arranged between the gasket and an interior volume of the cold-plate.

18. The battery of claim 17, wherein the tray comprises a plurality of coolant channels, wherein adjacent channels of the plurality of coolant channels are separated via dividers of the tray.

19. The battery of claim 17, wherein the interior volume is hermetically sealed apart from a coolant inlet and a coolant outlet arranged on the heat sink.

20. The battery of claim 17, wherein the frame is laser translucent and the tray is laser absorbent.
